(19) United States
(12) Patent Application Publication
(10) Pub. No.: US 2024/0343590 A1
(43) Pub. Date: Oct. 17, 2024

(54) METHOD FOR MANUFACTURING SILICON CLATHRATE ACTIVE MATERIAL, AND METHOD FOR MANUFACTURING LITHIUM ION BATTERY

(71) Applicant: TOYOTA JIDOSHA KABUSHIKI KAISHA, Toyota-shi (JP)

(72) Inventors: Takayuki UCHIYAMA, Susono-shi (JP); Mitsutoshi OTAKI, Susono-shi (JP)

(73) Assignee: TOYOTA JIDOSHA KABUSHIKI KAISHA, Toyota-shi (JP)

(21) Appl. No.: 18/581,783

(22) Filed: Feb. 20, 2024

(30) Foreign Application Priority Data
Apr. 17, 2023 (JP) 2023-067217

(51) Int. Cl. C01B 33/021; H01M 4/02; H01M 4/38; H01M 10/0525

(52) U.S. Cl. CPC C01B 33/021; H01M 4/386; H01M 10/0525; C01P 2002/08; C01P 2002/30; C01P 2004/82; H01M 2004/021; H01M 2004/027

(57) ABSTRACT

The present disclosure provides a method for manufacturing a silicon clathrate active material having a small expansion and a method for manufacturing a lithium ion battery including manufacturing such a silicon clathrate active material. The method of the present disclosure for manufacturing a silicon clathrate active material comprises oxidizing a surface of a sodium-containing silicon clathrate at least partially, and washing the oxidized sodium-containing silicon clathrate with an acid. The method of the present disclosure for manufacturing a lithium ion battery comprises manufacturing a silicon clathrate active material by the method of the present disclosure, and forming a negative electrode active material layer using the silicon clathrate active material.

### FIELD

The present disclosure relates to a method for manufacturing a silicon clathrate active material and a method for manufacturing a lithium ion battery.

### BACKGROUND

In recent years, there has been ongoing development of batteries. For example, in the automotive industry, the development of batteries for use in electric vehicles or hybrid vehicles has been advancing. Silicon is known as an active material used in batteries, especially in lithium ion batteries.

Silicon active materials have a large theoretical capacity and are effective in high energy densification of batteries. However, silicon active materials have a problem of large expansion during charging. In response, it is known that expansion during charging can be suppressed by using a silicon clathrate active material as a silicon active material.

For example, PTL 1 discloses a silicon clathrate active material comprising a silicon clathrate type II crystal phase and including voids inside primary particles, wherein a void amount of the voids having a fine pore diameter of 100 nm or less is 0.05 cc/g or more and 0.15 cc/g or less.

### CITATION LIST

### Patent Literature

[PTL 1] Japanese Unexamined Patent Publication (Kokai) No. 2021-158004

### SUMMARY

### Technical Problem

Although silicon clathrate active materials can suppress expansion during charging as compared to conventional silicon active materials, there is a demand for further suppressing expansion of silicon clathrate active materials during charging.

An object of the present disclosure is to provide a method for manufacturing a silicon clathrate active material having a small expansion during charging, and a method for manufacturing a lithium ion battery comprising manufacturing such a silicon clathrate active material.

### Solution to Problem

The present inventors have discovered that the above object can be achieved by the following means.

### <Aspect 1>

A method for manufacturing a silicon clathrate active material, comprising the following steps:
oxidizing a surface of a sodium-containing silicon clathrate at least partially, and
washing the oxidized sodium-containing silicon clathrate with an acid.

### <Aspect 2>

The method according to Aspect 1, wherein the surface of the sodium-containing silicon clathrate is at least partially oxidized by exposing a sodium-containing silicon clathrate to an ambient atmosphere.

### <Aspect 3>

The method according to Aspect 1 or 2, wherein the sodium-containing silicon clathrate has at least partially a clathrate II type structure.

### <Aspect 4>

The method according to any one of Aspects 1 to 3, wherein the sodium-containing silicon clathrate has a porous structure.

### <Aspect 5>

The method according to any one of Aspects 1 to 4, wherein the silicon clathrate active material is used as a negative electrode active material of a lithium ion battery.

### <Aspect 6>

A method for manufacturing a lithium ion battery, comprising
manufacturing a silicon clathrate active material by the method according to any one of Aspects 1 to 5, and
forming a negative electrode active material layer using the silicon clathrate active material.

### Advantageous Effects of Invention

According to the present disclosure, a method for manufacturing a silicon clathrate active material having a small expansion during charging, and a method for manufacturing a lithium ion battery including manufacturing such a silicon clathrate active material can be provided.

### DESCRIPTION OF EMBODIMENTS

Hereinafter, embodiments of the present disclosure will be described in detail. Note that the present disclosure is not limited to the following embodiments, and various modifications can be made thereto within the scope of the disclosure.

### <<Method for Manufacturing Silicon Clathrate Active Material>>

The method of the present disclosure for manufacturing a silicon clathrate active material comprises oxidizing a surface of a sodium-containing silicon clathrate at least partially, and washing the oxidized sodium-containing silicon clathrate with an acid.

The sodium-containing silicon clathrate used as a raw material in the present disclosure can be obtained in any manner. Generally, sodium-containing silicone clathrates can be formed by removing sodium from NaSi alloys (sodium silicone alloys).

For example, in the production of sodium-containing silicone clathrates, NaSi alloys are first prepared by reacting silicone with sodium hydride. Thereafter, a sodium-containing silicon clathrate can be prepared by reacting NaSi alloy thus prepared and aluminum fluoride as a sodium trapping agent.

At this time, in addition to the sodium-containing silicon clathrate, sodium fluoride, aluminum, and the like are generated as by-products. These by-products are removed by washing the reaction product with an acid.

The present inventors have unexpectedly discovered that by oxidizing the surface of the sodium-containing silicon clathrate at least partially, a silicon clathrate active material having a small expansion during charging can be produced.

Without intending to be bound by any theory, the reason therefor is considered to be because, by oxidizing the surface of the sodium-containing silicon clathrate, the efficiency of removing by-products in the subsequent acid washing is improved and the voids of the clathrate structure are easily secured.

A Method for oxidizing the surface of a sodium-containing silicone clathrate at least partially include, but is not particularly limited to, a method for exposing a silicone clathrate to an ambient atmosphere. Specifically, a method for placing a silicone clathrate into a device capable of decompressing and replacing gas, and after decompressing inside the device, introducing an atmosphere into the device is exemplified.

The sodium-containing silicon clathrate in the method of the present disclosure may have a clathrate II type structure at least partially. When the silicone clathrate has a clathrate II type structure, the expansion during charging is further reduced.

The sodium-containing silicon clathrate in the method of the present disclosure may have a porous structure. If the silicon clathrate has a porous structure, the expansion during charging is further reduced.

### <Uses>

The silicon clathrate active material in the method of the present disclosure may be used as a negative electrode active material of a lithium ion battery.

### <<Manufacturing Method for Lithium Ion Battery>>

The method of the present disclosure for manufacturing a lithium ion battery comprises manufacturing a silicon clathrate active material by the method of the present disclosure, and forming a negative electrode active material layer using the silicon clathrate active material.

By using the silicon clathrate active material produced by the method of the present disclosure, a battery having a small expansion during charging can be obtained.

The above descriptions relating to the method for manufacturing a silicon clathrate active material of the present disclosure can be referenced regarding the method for manufacturing a silicon clathrate active material.

A method for forming the negative electrode active material layer is not particularly limited, and a known method can be employed. For example, a slurry containing a silicon clathrate active material is coated on a negative electrode current collector and dried, whereby a negative electrode active material layer formed on a negative electrode current collector layer can be obtained.

A method for forming a battery is not particularly limited, and a known method can be employed.

In addition to manufacturing a silicon clathrate active material and forming a negative electrode active material layer using the silicon clathrate active material, a method for manufacturing a battery in the present disclosure may include forming a solid electrolyte layer and forming a positive electrode active material layer, and arranging a negative electrode current collector layer, a negative electrode active material layer, a solid electrolyte layer, a positive electrode active material layer, and a positive electrode current collector layer in this order.

### <Negative Electrode Current Collector Layer>

The material used for the negative electrode current collector layer is not particularly limited, and any material that can be used as a negative electrode current collector of a battery can be adopted as appropriate. For example, the material used for the negative electrode current collector layer may be copper, copper alloy, or copper plated or vapor-deposited with nickel, chromium, carbon, but is not limited thereto.

The shape of the negative electrode current collector layer is not particularly limited. Examples thereof can include foil-like, plate-like, and mesh-like. Among these, a foil-like shape is preferable.

### <Negative Electrode Active Material Layer>

The negative electrode active material layer of the present disclosure is a layer containing a negative electrode active material, and optionally a solid electrolyte, a conductive aid, and a binder.

### (Negative Electrode Active Material)

The negative electrode active material includes a silicon clathrate active material of the present disclosure.

### (Solid Electrolyte)

The material of the solid electrolyte is not particularly limited, and any material usable as a solid electrolyte used in lithium ion batteries can be used. For example, the solid electrolyte may be a sulfide solid electrolyte.

Examples of the sulfide solid electrolyte include, but are not limited to, sulfide amorphous solid electrolytes, sulfide crystalline solid electrolytes, and argyrodite-type solid electrolytes. Specific examples of the sulfide solid electrolyte can include, but are not limited to, Li₂S—P₂S₅-based (such as Li₇P₃S₁₁, Li₃PS₄, and LisP₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (such as Li₁₃GeP₃S₁₆ and Li₁₀GeP₂S₁₂), LiI—Li₂S—P₂O₅, LiI—Li₃PO₄—P₂S₅, and Li₇₋ₓPS₆₋ₓClₓ; and combinations thereof.

The sulfide solid electrolyte may be glass or crystallized glass (glass ceramics)

The mass ratio (mass of silicon clathrate active material: mass of solid electrolyte) of the silicon clathrate active material to the solid electrolyte in the negative electrode mixture is preferably 85:15 to 30:70, and more preferably 80:20 to 40:60.

### (Conduction Aids)

The conductive aid is not particularly limited. For example, the conductive aid may be, but is not limited to, VGCF (Vapor Grown Carbon Fiber), acetylene black (AB), Ketjen black (KB), carbon nanotube (CNT), and carbon nanofiber (CNF).

### (Binder)

The binder is not particularly limited. For example, the binder may be, but is not limited to, a material such as polyvinylidene fluoride (PVdF), butadiene rubber (BR), or styrene butadiene rubber (SBR), or a combination thereof.

The thickness of the negative electrode active material layer may be, for example, 0.1 to 1000 μm.

### <Solid Electrolyte Layer>

The solid electrolyte layer comprises at least a solid electrolyte. In addition, the solid electrolyte layer may comprise a binder in addition to the solid electrolyte, as needed. The above descriptions relating to the negative electrode active material layer of the present disclosure can be referenced regarding the solid electrolyte and the binder.

The thickness of the solid electrolyte layer is, for example, 0.1 to 300 μm, and is preferably 0.1 to 100 μm.

### <Positive Electrode Active Material Layer>

The positive electrode active material layer is a layer containing a positive electrode active material and optionally a solid electrolyte, a conductive aid, and a binder.

The material of the positive electrode active material is not particularly limited. For example, the positive electrode active material may be, but is not limited to, lithium cobaltate (LiCoO₂), lithium nickelate (LiNiO₂), lithium manganate (LiMn₂O₄), LiCo_{1/3}Ni_{1/3}Mn_{1/3}O₂, or a heteroelement-substituted Li—Mn spinel having a composition represented by Li₁₊ₓMn_{2-x-y}M_{y}O₄ (M is one or more metallic elements selected from Al, Mg, Co, Fe, Ni, and Zn), lithium titanate (LiₓTiO_{y}), and lithium metal phosphate (LiMPO₄, M is one or more metals selected from Fe, Mn, Co, and Ni).

The positive electrode active material can comprise a covering layer. The covering layer is a layer containing a material that has lithium-ion conducting performance, has low reactivity with the positive electrode active material and the solid electrolyte, and can maintain the form of a covering layer that does not flow even when brought into contact with the active material or the solid electrolyte. Specific examples of the material constituting the covering layer can include, but are not limited to, Li₄Ti₅O₁₂ and Li₃PO₄, in addition to LiNbO₃.

Examples of the shape of the positive electrode active material include particulate. The average particle size (D50) of the positive electrode active material is not particularly limited, and for example, is 10 nm or more, and may be 100 nm or more. The average particle size (D50) of the positive electrode active material, for example, is 50 μm or less, and may be 20 μm or less. The average particle size (D50) can be calculated from measurements with, for example, a laser diffraction particle size distribution analyzer or a scanning electron microscope (SEM).

The above descriptions relating to the negative electrode active material layer of the present disclosure can be referenced regarding the solid electrolyte, the conductive aid, and the binder.

When the positive electrode active material layer contains a solid electrolyte, the mass ratio (mass of positive electrode active material: mass of solid electrolyte) of the positive electrode active material to the solid electrolyte in the positive electrode active material layer is preferably 85:15 to 30:70, and more preferably 80:20 to 50:50.

The thickness of the positive electrode active material layers is, for example, 0.1 μm to 1000 μm, preferably 1 μm to 100 μm, and more preferably 30 μm to 100 μm.

### <Positive Electrode Current Collector Layer>

The material used for the positive electrode current collector layer is not particularly limited, and any material that can be used as a positive electrode current collector of a battery can be adopted as appropriate. For example, the material used for the positive electrode current collector layer may be SUS, nickel, chromium, gold, platinum, aluminum, iron, titanium, zinc, or these metals plated or vapor-deposited with nickel, chromium, carbon, but is not limited thereto.

The shape of the positive electrode current collector layer is not particularly limited. Examples thereof can include foil-like, plate-like, and mesh-like. Among these, a foil-like shape is preferable.

### EXAMPLES

### <<Synthesis of Silicon Clathrate Active Material>>

### Comparative Example 1

As a silicone (Si) source, Si powder (Japan Pure Chemical Co., Ltd., SIEPB32) was prepared. The Si powder and metallic lithium (Li) were weighed at a molar ratio of Li/Si=4.0. The weighed Si powder and Li were mixed in a mortar in an argon atmosphere to obtain lithium-silicon (LiSi) alloys. The obtained LiSi alloys were reacted with ethanol in an argon atmosphere and further treated with hydrogen fluoride (HF) to obtain Si powder having primary particles with voids therein, i.e., Si powder having a porous structure.

The Si powder having a porous structure and sodium hydride (NaH) as a sodium (Na) source were used to manufacture a sodium-silicon (NaSi) alloy. Note that the NaH used was preliminarily washed with hexane. NaH and the Si powder having a porous structure were weighed at a molar ratio of 1.05:1, and the weighed NaH and Si powder having a porous structure were mixed with a cutter mill. The obtained mixture was heated under the conditions of 500° C. for 40 h in an argon atmosphere with a heating furnace to obtain powdery NaSi alloys.

The obtained NaSi alloys and aluminum fluoride (AlF₃) were weighed at a molar ratio of 1:0.35, and the weighed NaSi alloys and AlF₃ were mixed with a cutter mill to obtain a reaction material. The obtained powdery reaction material was placed in a reaction vessel made of stainless steel, and heated under the conditions of 310° C. and 60 h in an argon atmosphere with a heating furnace to obtain a reaction product comprising sodium-containing silicon clathrate. The obtained reaction product was acid-washed using a mixed solvent of HNO₃ and H₂O mixed at a volume ratio of 90:10 to remove by-products in the reaction product. After washing, the reaction product was filtered and filtered solid content was dried at 120° C. for 3 h or more to obtain a powdery silicon clathrate active material. The obtained material was further washed with a 3-wt % HF solution, filtered, and then dried at 120° C. for 3 h or more to obtain a silicon clathrate active material of Comparative Example 1.

### Example 1

The silicone clathrate active material of Example 1 was obtained in the same manner as in Comparative Example 1 except that the following procedure: prior to acid washing with a mixed solvent of HNO₃ and H₂O, the reaction product was placed in a device capable of decompressing and replacing gas, and after decompressing inside the device at room temperature, an atmosphere was introduced into the device to oxidize the reaction product.

### <<Production of Lithium Ion Cell>>

Using the silicon clathrate active material of each example, a lithium-ion cell of each example was produced as follows.

### <Formation of Negative Electrode Active Material Layer>

Butyl butyrate, 5-wt % butyl butyrate solution of a polyvinylidene fluoride (PVDF)-based binder, vapor-grown carbon fiber (VGCF) as the conductive aid, the synthesized silicon clathrate active material, and a Li₂S—P₂S₅-based glass ceramic as the sulfide solid electrolyte were added to a polypropylene container and stirred with an ultrasonic dispersion apparatus (UH-50 manufactured by SMT) for 30 s. The container was then shaken with a shaker (TTM-1 manufactured by Sibata Scientific Technology Ltd.) for 30 μmin to obtain a negative electrode mixture slurry.

The obtained negative electrode mixture slurry was applied onto a copper (Cu) foil as a negative electrode current collector layer by a blade method using an applicator and dried for 30 min on a hot plate heated to 100° C. to form a negative electrode active material layer on the negative electrode current collector layer.

### <Formation of Solid Electrolyte Layer>

Heptane, 5-wt % heptane solution of a butadiene rubber (BR)-based binder, and a Li₂S—P₂S₅-based glass ceramic as the sulfide solid electrolyte were added to a polypropylene container and stirred with an ultrasonic dispersion apparatus (UH-50 μmanufactured by SMT) for 30 s. The container was then shaken with a shaker (TTM-1 μmanufactured by Sibata Scientific Technology Ltd.) for 30 μmin to obtain a solid electrolyte slurry.

The obtained solid electrolyte slurry was applied onto an aluminum (Al) foil as a release sheet by a blade method using an applicator and dried for 30 μmin on a hot plate heated to 100° C., whereby a solid electrolyte layer was formed. Three solid electrolyte layers were produced.

### <Formation of Positive Electrode Active Material Layer>

Butyl butyrate, 5-wt % butyl butyrate solution of a PVDF-based binder, LiNi_{1/3}Co_{1/3}Mn_{1/3}O₂ having an average particle size of 6 μm as the positive electrode active material, a Li₂S—P₂S₅-based glass ceramic as the sulfide solid electrolyte, and VGCF as the conductive aid were added to a polypropylene container and stirred with an ultrasonic dispersion apparatus (UH-50 μmanufactured by SMT) for 30 s.

The container was then shaken with a shaker (TTM-1 μmanufactured by Sibata Scientific Technology Ltd.) for 3 μmin, further stirring was carried out with the ultrasonic dispersion apparatus for 30 s, and the container was shaken with the shaker for 3 μmin to obtain a positive electrode mixture slurry.

The obtained positive electrode mixture slurry was applied onto an Al foil as a positive electrode current collector layer by a blade method using an applicator and dried for 30 μmin on a hot plate heated to 100° C., whereby a positive electrode active material layer was formed on the positive electrode current collector layer.

### <Assembly of Cell>

The positive electrode current collector layer, the positive electrode active material layer, and a first solid electrolyte layer were laminated in this order. The laminated product was set in a roll press machine and pressed at a pressing pressure of 100 kN/cm and a pressing temperature of 165° C., whereby a positive electrode laminated body was obtained.

The negative electrode current collector layer, the negative electrode active material layer, and a second solid electrolyte layer were laminated in this order. The laminated product was set in a roll press machine and pressed at a pressing pressure of 60 kN/cm and a pressing temperature of 25° C., whereby a negative electrode laminated body was obtained.

The Al foil as a release sheet was peeled off from the solid electrolyte layer surface of each of the positive electrode laminated body and the negative electrode laminated body. The Al foil as a release sheet was then peeled off from a third solid electrolyte layer.

The positive electrode laminated body and the negative electrode laminated body were set so that the solid electrolyte layer side of each thereof faced the third solid electrolyte layer and laminated to each other. The laminated body was set in a flat uniaxial press machine and temporarily pressed at 100 MPa and 25° C. for 10 s. The laminated body was finally set in the flat uniaxial press machine and pressed at a pressing pressure of 200 MPa and a pressing temperature of 120° C. for 1 μmin. As a result, an all-solid-state battery was obtained.

### <<Evaluation>>

### <Measurement of Restraining Pressure Increase>

The restraining pressure increase of the produced cell when restrained at a predetermined restraining pressure using a restraining jig and charged by constant current-constant voltage to 4.55 V at a 10-h rate ( 1/10 C) was measured. Note that the restraining pressure increase is the difference between the highest value and the lowest value in restraining pressure. The value of the Example 1 is shown as relative values when the value of Comparative Example 1 was set to 1.00.

### <<Results>>

The measurement results of restraining pressure increase of the silicon clathrate active material of each example is shown in Table 1

TABLE 1

| | | Restraining |
|---|---|---|
| | Oxidation | pressure increase |
| Comparative Example | No | 1.00 |
| Example | Yes | 0.76 |

As shown in Table 1, the silicon clathrate active material of Example 1, in which the surface of the sodium-containing silicon clathrate was oxidized prior to acid washing, had a small amount of restraining pressure increase, that is, expansion.

1. A method for manufacturing a silicon clathrate active material, comprising the following steps:
oxidizing a surface of a sodium-containing silicon clathrate at least partially, and
washing the oxidized sodium-containing silicon clathrate with an acid.

2. The method according to claim 1, wherein the surface of the sodium-containing silicon clathrate is at least partially oxidized by exposing a sodium-containing silicon clathrate to an ambient atmosphere.

3. The method according to claim 1, wherein the sodium-containing silicon clathrate has at least partially a clathrate II type structure.

4. The method according to claim 1, wherein the sodium-containing silicon clathrate has a porous structure.

5. The method according to claim 1, wherein the silicon clathrate active material is used as a negative electrode active material of a lithium ion battery.

6. A method for manufacturing a lithium ion battery, comprising
manufacturing a silicon clathrate active material by the method according to claim 1, and
forming a negative electrode active material layer using the silicon clathrate active material.
